(19) United States
(12) Patent Application Publication
(10) Pub. No.: US 2019/0029285 A1
(43) Pub. Date: Jan. 31, 2019

(54) Grinder Cleaner

(71) Applicant: Cafetto Pty Ltd, Brompton (AU)

(72) Inventors: Christopher Short, Brompton (AU); Damien Rankine, Brompton (AU)

(73) Assignee: Cafetto Pty Ltd, Brompton (AU)

(21) Appl. No.: 16/074,569

(22) PCT Filed: Feb. 2, 2017
(86) PCT No.: PCT/AU2017/000035

§ 371 Date: Aug. 1, 2018

(30) Foreign Application Priority Data
Feb. 2, 2016 (AU) 2016900331

(51) Int. Cl. A23F 5/02; A23F 5/26

(52) U.S. Cl. CPC A23F 5/02; B08B 7/04; A23F 5/267

(57) ABSTRACT

A method for producing a grinder cleaner for cleaning food residue from a food processing grinder is disclosed. The method includes processing green coffee beans to form depleted coffee beans, wherein the depleted coffee beans have enhanced cleaning characteristics that allow the depleted coffee beans to clean food residue from the food processing grinder upon grinding of the depleted coffee beans. In one embodiment, the grinder cleaner is for cleaning a coffee grinder.

### PRIORITY DOCUMENTS

The present application claims priority from Australian Provisional Patent Application No. 2016900331 titled “Grinder Cleaner” and filed on 2 Feb. 2016, the content of which is incorporated by reference in its entirety.

### TECHNICAL FIELD

The present disclosure relates to the cleaning of food processing equipment. In a particular form, the present disclosure relates to the cleaning of food processing grinders such as coffee bean grinders and the like.

### BACKGROUND

A by-product of grinding foodstuffs such as pepper, spices and roasted coffee beans is that a residual amount of the foodstuff being ground can remain on the grinding surfaces. This effect can be exacerbated when the foodstuff contains a proportion of oil resulting in a resinous material being deposited on the grinding surfaces. This residual material, if it is not cleaned from the grinding surfaces, can go off or rancid which will then affect the taste of any subsequent foodstuff that is being ground. Even where the foodstuff is unlikely to go off, the presence of this residual material will contaminate the grinding of a different foodstuff. As an example, a spice grinder that first grinds one spice and is then used to grind a different spice without cleaning will often result in contamination of the second spice with residual amounts of the first spice.

In the case of roasted coffee beans, these contain extractable materials such as oils, polyphenols, flavonoids and other phytochemicals including caffeine which are left on the grinding surfaces. As the proportion of oils and other materials are relatively high in roasted coffee beans, i.e. 8-18% of oil/fat by weight, these materials can adhere directly to the grinding surfaces, in turn binding particulate matter to the surface and reducing the grinder's performance as well as potentially becoming sticky and rancid, due to lipid oxidation, and imparting negative flavour characteristics to subsequent roasted coffee beans ground in the coffee grinder. In addition, initial grinding of flavoured coffee beans will “contaminate” the grinding surfaces should the grinder be used with standard coffee beans or beans of a different flavour.

One way to clean the grinding surfaces is to disassemble the grinding machine to allow direct brushing and washing of these surfaces. This is clearly a time consuming task. Taking a coffee bean grinder as an example, this will require almost complete disassembly of the grinder to allow access to the grinding burrs. In the case of super-automatic coffee machines the grinders are difficult to access. Furthermore, as most grinders, including coffee grinders, are electrically powered, liquid cannot be introduced into the grinder as a cleaning aid. In any event, even if liquid was able to be introduced there is then the difficulty of drying the grinder components. Following the cleaning process, the grinder will also require setup and retuning, adding valuable time to the cleaning process.

One attempt to address this problem has been to introduce a material in the grinder, which when ground, functions to clean the grinding surfaces before exiting the grinder. Some examples of materials that have been employed in this manner include naturally occurring organic substances such as rice or bulgur wheat to artificially produced products again, typically based on organic substances but in either powder, pellet or tablet form.

In the case of materials in the form of powder or crystals, these can easily pass through the grinding mechanism without engaging the entirety of the grinding surfaces, providing poor abrasive cleaning action and in the process producing dust as a waste by-product. Similarly, the introduction of raw organic material, such as rice or bulgur wheat, fails to clean the entirety of the grinding surfaces due to its small size. In addition, uncooked and partially cooked rice is very hard and can cause the grinder to seize during the cleaning process leading to motor failure, wear along the sharp burr edges, as well as the production of dusty starch material that often requires manual brushing to remove.

There have been some attempts to provide a grinder cleaner comprising organic material packaged in a more friable tabletted form, to minimise the risk of grinder blockage and motor damage. However, these tablets crush easily to a powder leaving a large amount of dusty residue without cleaning the entirety of the grinding surfaces. Where the organic material for the tablet employs wheat as a key ingredient, this can then introduce gluten into the cleaning process leading to contamination of the grinder or the generation of gluten dust generally. This may pose a risk to users who have severe gluten intolerance such as those who suffer from coeliac disease.

There is therefore a need for a grinder cleaning for cleaning the grinding surfaces of a food processing grinder that is food safe and convenient to use and/or provides the consumer with a commercial alternative to products on the market.

### SUMMARY

In a first aspect, the present disclosure provides a method for producing a grinder cleaner for cleaning food residue from a food processing grinder, the method including processing green coffee beans to form depleted coffee beans, wherein the depleted coffee beans have enhanced cleaning characteristics allowing the depleted coffee beans to clean food residue from the food processing grinder upon grinding of the depleted coffee beans.

In another form, processing the green coffee beans includes:

extracting active components from the green coffee beans to produce processed green coffee beans; and

drying the processed coffee beans to form the depleted coffee beans.

In another form, extracting active components from the green coffee beans includes one or more of the following processes:

aqueous extraction;

acidic or alkaline aqueous solution based extraction;

extraction by a volatile alcohol, including extraction by methanol, ethanol or isopropanol;

organic solvent extraction;

extraction by an oxidising or reducing agent;

extraction by an enzyme or biological agent;

extraction by a surface-active agent;

super or sub-critical fluid extraction; or

distillation based extraction.

In another form, extracting the active components from the green coffee beans further includes expanding the green coffee beans to form expanded beans of increased physical size.

In another form, expanding the green coffee beans assists in the extraction of active components from the green coffee beans.

In another form, expanding the green coffee beans includes soaking the green coffee beans in a liquid to cause them to swell.

In another form, drying the processed coffee beans includes one or more of the following processes:

conventional oven/heated drying;

microwave drying;

freeze-drying;

super or sub-critical fluid drying;

ambient drying;

chemical drying by a water absorbing material;

modified pressure drying; or puffing.

In another form, the formed depleted coffee beans have a moisture content less than or about 4%.

In another form, the moisture content is less than or about 1%.

In another form, the formed depleted coffee beans have a hardness of less than or about 125 N.

In another form, the hardness is less than or about 75 N.

In another form, the formed depleted coffee beans have a hardness no harder than the original coffee beans.

In another form, the formed depleted coffee beans have a percentage size increase of about or greater than 50%.

In another form, the percentage size increase is about or greater than 75%.

In another form, the formed depleted coffee beans have a reduction in extractable fat content of about or greater than 50%.

In another form, the reduction in extractable fat content is about or greater than 90%.

In another form, the formed depleted coffee beans have a density of less than or about 0.5 g/cm³.

In another form, the density is less than or about 0.4 g/cm³.

In a second aspect, there is provided a grinder cleaner comprising the depleted coffee beans formed by the method in accordance with the first aspect of the present disclosure.

In a third aspect, there is provided a method for cleaning food residue from a food processing grinder including:

introducing the grinder cleaner of the second aspect into the food processing grinder;

grinding the depleted coffee beans; and

purging the ground depleted coffee beans from the grinder.

In another form, the food processing grinder is a coffee grinder.

### BRIEF DESCRIPTION OF DRAWINGS

Embodiments of the present disclosure will be discussed with reference to the accompanying drawings wherein:

FIG. 1 is a process flowchart of a method for producing a grinder cleaner for cleaning food residue from a food processing grinder according to a first illustrative embodiment;

FIG. 2 is a process flowchart of a method for producing a grinder cleaner for cleaning food residue from a food processing grinder according to a second illustrative embodiment;

FIG. 3 is a process flowchart of the method illustrated in FIG. 2 depicting the different extraction and expansion combinations according to various illustrative embodiments;

FIG. 4 is a process flowchart depicting an illustrative embodiment of a method for forming depleted coffee beans for use as a grinder cleaner;

FIG. 5 is a process flowchart depicting another illustrative embodiment of a method for forming depleted coffee beans for use as a grinder cleaner;

FIG. 6 is a process flowchart depicting yet another illustrative embodiment of a method for forming depleted coffee beans for use as a grinder cleaner;

FIG. 7 is a process flowchart depicting a further illustrative embodiment of a method for forming depleted coffee beans for use as a grinder cleaner; and

FIG. 8 is a process flowchart depicting a final illustrative embodiment of a method for forming depleted coffee beans for use as a grinder cleaner.

In the following description, like reference characters designate like or corresponding parts throughout the figures.

### DESCRIPTION OF EMBODIMENTS

Referring now to FIG. 1, there is shown a flowchart of a method 100 for producing a grinder cleaner for cleaning food residue from a food processing grinder. In this example, the grinder cleaner is for cleaning coffee residue from a coffee grinder. Method 100 includes as its input green coffee beans 110A and generates as its output grinder cleaner 110B in the form of depleted coffee beans that have enhanced physical characteristics that remove food residue from the food processing grinder.

The term “depleted coffee bean(s)” as used throughout the specification is defined to be a green coffee bean that has had its active components substantially extracted or removed yet with the processed coffee bean still substantially maintaining the same structural/physical integrity of the original green coffee bean. In this context, relevant active components include one or more of oils, fats, carbohydrates, proteins, sugars, polyphenols, flavonoids and other phytochemicals, including alkaloids such as caffeine.

The Applicant has recognised that, as an example, a coffee grinder is optimised to grind coffee beans and so coffee beans that have been suitably processed to form depleted coffee beans, having enhanced cleaning characteristics, will optimally clean the coffee grinder by a combination of physical removal and adsorption of the coffee residue from the grinding components of the coffee grinder. In one non-limiting example, a grinder cleaner formed in accordance with the present disclosure may be added to the coffee bean hopper of a domestic, commercial or super-automatic coffee machine, ground through the grinding burrs and in the process remove residual foodstuffs in the form of coffee residue typically consisting of oils, fats, carbohydrates, protein, polyphenols, flavonoids and other phytochemicals including caffeine and particulates from the grinding surfaces.

As would be appreciated, a depleted coffee bean may also be employed in other types of food processing grinders including, but not limited to, salt and pepper grinders, spice grinders, herb grinders, cheese grinders and meat grinders.

In one example, the green coffee beans are Robusta or Arabica coffee beans or a blend of these types.

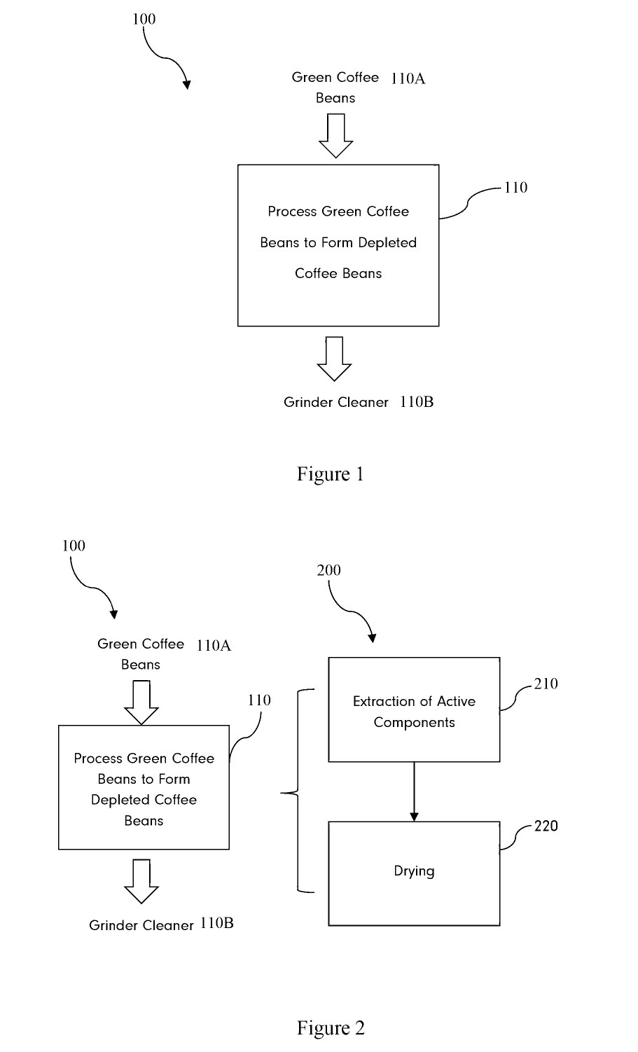

Referring now to FIG. 2, there is shown a flowchart of a method 200 for processing green coffee beans to form depleted coffee beans including a first extraction step 210 and a second drying step 220 according to an illustrative embodiment. In this embodiment, the extraction step 210 functions to substantially remove the active components of the green coffee bean to produce a processed bean that comprises predominantly polysaccharides and protein components of the green coffee bean. In this manner, the cleaning characteristics of the processed green coffee bean are enhanced in that the processed bean is now able to adsorb residual material such as lipophilic residue, and other contaminant material, from the grinding surfaces of the food processing grinder upon grinding of the processed green coffee beans in the grinder.

Examples of different extraction processes that may be employed include, but are not limited to, one or more of:

water extraction;

extraction employing acidic or alkaline aqueous solutions;

volatile alcohol based extraction including, but not limited to, methanol, ethanol or isopropanol (under ambient or modified pressure conditions);

extraction employing surface-active agents including, but not limited to, structural derivatives of the following surfactant types: alkyl sulfates; alkyl sulfonates; alkyl succinates; alkyl sarcosinates; alkyl polyglycosides; alkyl amines; alkyl alkanolamides; alkyl amine ethoxylates alkoxylated alcohols; N-alkyl quaternary ammonium compounds; alkyl amidopropyl betaines; alkyl aminopropyl sultaines; or alkyl amine oxides;

extraction employing enzymes, or functional biological products, to assist in modifying the chemical composition of the bean, including but not limited to, protease, lipase, amylase or pectinase enzymes

extraction employing oxidising or reducing agents including, but not limited to, hydrogen peroxide; organic peroxides, such as peroxy acetic acid, phthalimido peroxyhexanoic acid or nonanoyloxy benzenesulfonate; inorganic oxidisers or activators, such as potassium monopersulfate or manganese (II) oxalate; or reducing agents, such as sodium metabisulfite or hydroxylamine hydrochloride;

supercritical fluid (SCF) extraction including, but not limited to the use, or combined use, of, CO₂, water, methane, acetone, short-chain aliphatic alcohols, and short-chain saturated or unsaturated hydrocarbons, such as, but not limited to, ethane, propane, butane, ethylene, propylene etc.;

organic solvent extraction including, but not limited to, the use of hexane, pentane, petroleum fractions/distillates, acetone, diethyl ether, ethyl acetate, dialkyl ethers, halogenated methanes or hydrocarbons; or

extraction involving distillation, including steam, vacuum or other forms.

Each of the above extraction processes or combination of processes may also be undertaken under modified pressure conditions, including employing negative or positive pressure in the extraction process as required.

As would be appreciated, different considerations will govern which extraction process or combination of process are selected including energy use considerations, equipment costs, the desire to avoid particular ingredients, local regulatory requirements, the ability to selectively extract components from the green coffee beans and/or overall expected throughput. As a general comment, solvents will generally be used in pure or neat form, however, in the case of acidic or alkaline aqueous solutions, concentrations of between 2% and 4% have proven effective in producing depleted green beans to provide the desired physicochemical properties.

Referring again to FIG. 2, in this embodiment drying step 220 functions to enhance the cleaning characteristics of the depleted coffee bean by ensuring that the resulting processed green coffee bean, following extraction, has the combination of hardness and brittleness to provide an enhanced abrasive action to physically remove material from the grinding burrs, yet not cause blockage of any moving parts. As a general comment, it is desirable that the processed coffee bean at least retain its size and shape during the drying process to avoid hardening if the coffee bean was to substantially contract.

Examples of different drying processes that may be applicable include, but are not limited to one or more of:

conventional oven/heated drying, including, but not limited to, commercial dehydrators or convection ovens;

microwave drying;

freeze drying;

super or sub-critical fluid drying;

ambient drying, in contained areas or open to sunlight and environmental elements;

modified pressure drying, for example, drying under reduced pressure;

chemical drying, using desiccating materials or solvents able to absorb water; or

puffing, as employed in food production such as processing of cereals.

As with extraction processes, different considerations will determine which drying process or combination of drying processes are selected. Where process time is not critical, ambient drying processes may be more attractive. In other circumstances, the use of puffing processes involving a rapid pressure change that causes the release of trapped moisture and subsequent expansion of the processed coffee bean to produce a dry puffed depleted coffee bean of increased physical size may be applicable. In other circumstances, other techniques such as oven, microwave, chemical or reduced pressure drying may be more applicable, as well as those processes which are more energy intensive, such as freeze-drying and supercritical fluid drying.

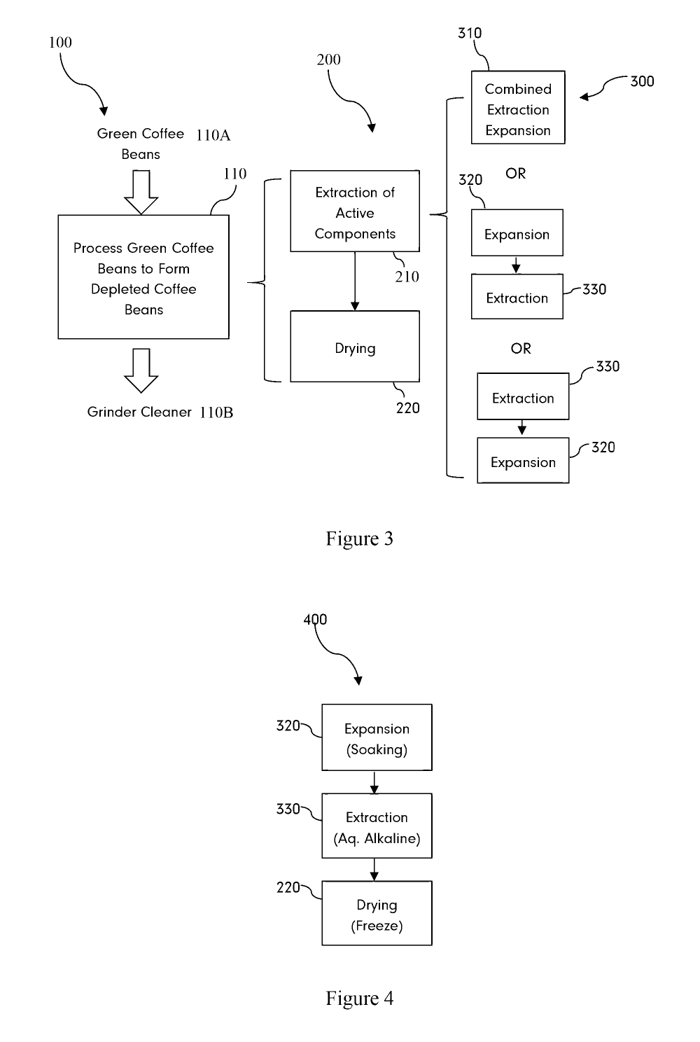

Referring now to FIG. 3, there is shown an elaboration of the extraction step 210 as shown in FIG. 2 further incorporating a further expansion step or steps 300 according to other illustrative embodiments incorporating a combined extraction and expansion process 310 or separate individual expansion 320 and extraction 330 processes as depicted in FIG. 3. Some examples of these different processes will be referred to below.

In these examples, the expansion step functions to expand or swell the size of the green coffee bean but still substantially maintain the structural integrity of the bean. This typically results in a processed coffee bean having enhanced cleaning characteristics in the form of a depleted coffee bean having reduced compressive strength, ie more brittle, and hence more readily ground by the grinding surfaces of the food processing grinder which can reduce the potential for clogging depending on the grinding mechanism. In addition, the expansion process will generally assist the extraction of active components in the extraction process.

Some example methods for producing a grinder cleaner will now be described.

### Method 1 (Hot Water, 2% Aqueous KOH, Citric Buffer, Freeze Drying)

Referring now to FIG. 4, there is shown a method 400 for forming depleted coffee beans according to an illustrative embodiment. In this illustrative method, the extraction process 210 (see FIG. 2) includes an initial expansion step 320 as depicted in one of the examples in FIG. 3. The expansion process 320 involves a soaking step where the green coffee beans, eg, green Robusta coffee beans, are soaked in unfiltered tap water and heated to 60° C. where they remain for a period of 2-12 hours. In this example, 5 L of water is used for each kilogram of green coffee beans. This initial expansion step results in a swelling or expansion of the bean structure, of up to 50% of the original size while still maintaining the structural integrity and hence the shape of the coffee bean. The expanded coffee beans are then filtered hot, using a 2 mm mesh sieve and the filtrate discarded.

The extraction process 330 involves a 2% aqueous KOH solution being added to the expanded beans and allowed to stand (60° C., 2-12 h). The solid is filtered carefully and soaked in cold water for 10 mins. To the resulting brown beans a 5% citric/citrate buffer (pH 5) is added and allowed to stand for 2-12 hours at room temperature. The beans are collected by filtration and cold water added, which is allowed to stand for 15 mins. This process functions to remove the KOH solution and then correct the pH of the processed green coffee bean to that of a regular coffee bean, ie pH of around 5-6.

Following the extraction of active components 210, the processed coffee beans are filtered and then dried 210, under standard commercial freeze drying conditions, to produce a depleted coffee bean having a moisture content of less than 5%. In other embodiments, the moisture content may be reduced to less than 1%.

In summary, Method 1 accordingly involves processing green coffee beans by:

expanding the green coffee beans by soaking in heated water;

extraction of active components from the expanded green coffee beans employing an aqueous alkaline solution and then an acidic solution to produce processed green coffee beans; and

drying the processed green coffee beans by freeze drying to form the depleted coffee beans for cleaning food residue from a food processing grinder.

This process has been found by the Applicant to generate consistent and reproducible depleted coffee beans where the freeze-drying maintains the expanded or swollen structure of the bean that is generated by soaking in hot water. This creates a lower density product (ρ=0.4 g/cm³) that displays low compressive strength and which is of an appropriate brittleness suitable for use in a coffee grinder.

### Method 2 (Hot Water, Hot 3.5% Aqueous Sodium Hydroxide, Cold Aqueous Buffer, Freeze Drying)

Referring again to FIG. 4, in this embodiment as with Method 1, the extraction process 210 includes an initial expansion step 320 where softened water is added to green Robusta coffee beans in a proportion of 3.3 L used for each kilogram of green coffee beans and heated at 60-70° C. with stirring for a period of 2-12 hours in a suitably sized stainless steel tank. The beans are then filtered hot, using a 4 mm mesh sieve, the filtrate discarded and the beans returned to the tank. Hot water is then added, stirred for 5 mins and filtered.

Cold softened water is then added to the beans, followed by 50% NaOH solution in proportion to generate a 3.5% aqueous solution and allowed to stir at 60-70° C. for a period of 2-12 hours. The solid is then filtered carefully and soaked in cold water for 30 minutes. The solution is decanted, with sieving, and discarded. To the resulting beans, a 5% citric/citrate buffer (pH 5) is then added and allowed to stand for 1 hour at room temperature. Following this step, the solution is decanted, with sieving, cold water added and allowed to stand for 30 minutes.

The beans are then collected and freeze-dried to produce a depleted coffee bean having a moisture content of less than 1%.

In summary, Method 2 accordingly involves processing green coffee beans by:

expanding the green coffee beans by soaking in heated softened water;

extraction of active components from the expanded green coffee beans employing an aqueous alkaline solution and then an acidic solution to produce processed green coffee beans; and

drying the processed green coffee beans by freeze drying to form the depleted coffee beans for cleaning food residue from a food processing grinder.

As would be appreciated, the process of freeze drying is chiefly used to dry and preserve the structural integrity of delicate or sensitive material. In this example, the process of freeze drying will allow the depleted coffee beans to substantially retain their expanded state as it minimises the tendency of the processed beans to contract upon drying which may occur under alternative drying conditions.

### Method 3 (Hot Water, 2% Aqueous KOH, Citric Buffer, Microwave Drying)

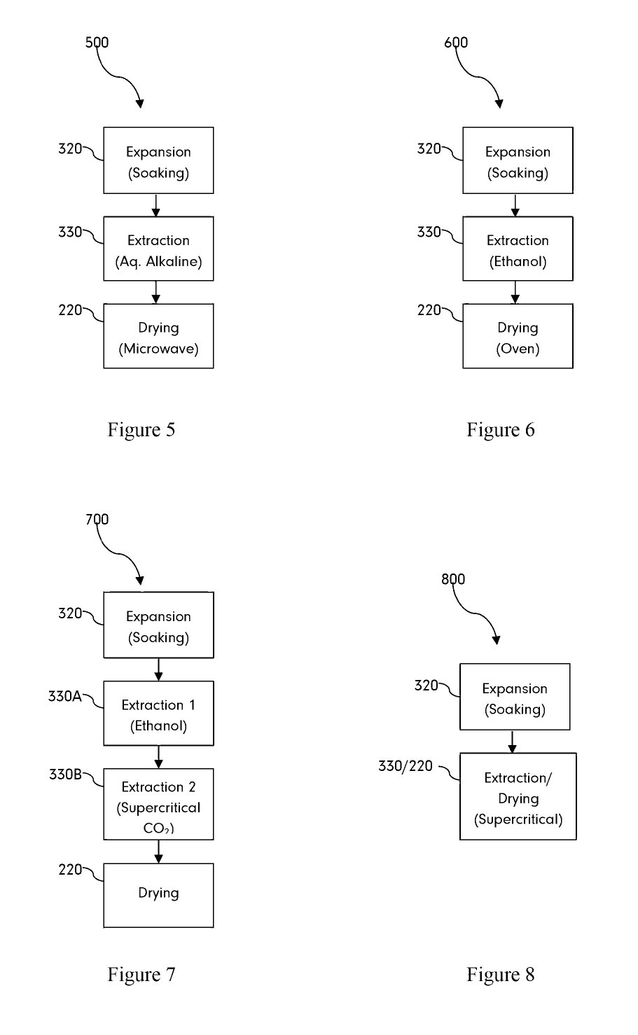

Referring now to FIG. 5, there is shown a method 500 for forming depleted coffee beans according to an illustrative embodiment. As with Methods 1 and 2, this illustrative method includes an initial expansion step 320 following which the expanded beans are filtered hot, using a 2 mm mesh sieve, and the filtrate then discarded. Extraction 330 then involves a 2% aqueous KOH solution being added to the beans and allowed to stand at 60° C. for 2-12 hours. The solid is filtered carefully and soaked in cold water. To the resulting beans a 5% citric/citrate buffer (pH 5) is added and allowed to stand for 1 hour at room temperature. The beans are then collected by filtration and cold water added and allowed to soak for 15 minutes.

Following the extraction of active components 210, the processed coffee beans are filtered and then dried 210 by in this embodiment spreading the processed coffee beans evenly in a single layer across a glass tray before being irradiated in a microwave oven. The intensity and length of irradiation will depend on the type of microwave source. For a typical commercial microwave oven having a power output of 1900 W, it has been found that a drying time of 8 minutes is required at 100% intensity to produce a coffee bean having a moisture content of less than 6%. As would be appreciated, for a commercial dryer using a microwave source, the drying time will vary depending on the required temperature, ramping rate and microwave surface power density.

In summary, Method 3 accordingly involves processing green coffee beans by:

expanding the green coffee beans by soaking in heated softened water;

extraction of active components from the expanded green coffee beans employing an aqueous alkaline solution and then an acidic solution to produce processed green coffee beans; and

drying the processed green coffee beans by microwave drying to form the depleted coffee beans for cleaning food residue from a food processing grinder.

In contrast to the other methods of drying, microwave drying has been found to require tighter process control in relation to the drying parameters so as not to “overcook” the processed green beans which in itself may produce unwanted flavour compounds and reducing the effectiveness of the depleted coffee beans as a grinder cleaner.

### Method 4 (Hot Water, Ethanol, Convection Oven Drying)

Referring now to FIG. 6, there is shown a method 600 for forming depleted coffee beans according to a further illustrative embodiment. The expansion step 320 again involves a soaking process where unfiltered tap water is added to green Robusta coffee beans in a proportion of 10 litres for every kilogram of green coffee beans and heated at 60° C. for 4 hours. The beans are then filtered hot, using a 2 mm mesh sieve, the filtrate discarded and the beans soaked in cold water for 30 minutes. The beans are then collected by filtration and dried briefly at standard temperature and pressure.

The extraction process 330 involves adding ethanol at 95% or absolute concentration in the proportion of 2 L for every kilogram of coffee beans and the solution is allowed to stand for 15 minutes. The ethanol is decanted and replaced every 20 minutes for 1 hour before the beans are filtered.

Following the extraction of active components 210, the processed coffee beans are filtered and then dried 210 by employing a conventional fan forced oven operating at 103° C. for a period of 3 hours, or until the analysed moisture content is less than 4%. The dried depleted coffee beans are then allowed to cool to room temperature.

In summary, Method 4 accordingly involves processing green coffee beans by:

expanding the green coffee beans by soaking in heated water;

extraction of active components from the expanded green coffee beans employing an alcohol based solution to produce processed green coffee beans; and

drying the processed green coffee beans by convection drying to form the depleted coffee beans for cleaning food residue from a food processing grinder.

The Applicants have found that the addition of ethanol to the expanded beans facilitates some degree of water removal by solvent exchange both outside and within the bean structure. Three successive stages of soaking and decanting with ethanol were also found to allow for greater desiccation of the final product, and greater retention of the expanded bean structure. This method can also be included as an additional step in other production methods as a way of reducing the water content prior to any final drying stage or stages.

### Method 5 (Water, Ethanol, Supercritical CO₂ Extraction)

Referring now to FIG. 7, there is shown a method 700 for forming depleted coffee beans according to a yet another illustrative embodiment that employs multiple extraction stages. The expansion step 320 involves unfiltered tap water being added to green Robusta coffee beans in a proportion of 10 litres for every kilogram of green coffee beans and heated at 40° C. for 4 hours. The beans are filtered, the filtrate discarded and the beans soaked in cold water for a period of 30 mins. The beans are then collected by filtration and dried briefly at standard temperature and pressure.

Similar to Method 4, the initial extraction process 330A involves adding ethanol at 95% or absolute concentration in the proportion of 2 L for every kilogram of coffee beans and the solution is allowed to stand for 15 minutes. The ethanol is decanted and replaced every 20 minutes for 1 hour.

Following this initial extraction process, the beans are then subjected to supercritical CO₂ extraction 330B, with either neat CO₂ or a CO₂ co-solvent mixture, where the co-solvent can be any additive that is miscible in supercritical CO₂ and included for the purpose of modifying the solubility of target chemical compounds. Ideally, a 95:5 mixture of CO₂/alcohol can be used, where the alcohol may be any aliphatic alcohol, but preferably ethanol or isopropanol.

A stepped method of increasing pressure, up to a potential maximum of 1000 bar, but more likely up to 600 bar, may be used to extract a broad range of target compounds, at temperatures not exceeding 100° C. A final extraction using neat CO₂ is used to purge the beans of any co-solvent, after which slow release of the pressure within the vessel ensures the structural integrity of the bean is maintained. This also results in a concurrent initial drying process as water is miscible with the supercritical CO₂ and will be removed by this final extraction or purging process.

Following the extraction of active components 330B and the associated drying, the processed coffee beans are filtered and then dried 210 at standard temperature and pressure for 1 hour.

In summary, Method 5 accordingly involves processing green coffee beans by:

expanding the green coffee beans by soaking in heated water;

extraction of active components from the expanded green coffee beans in a first stage employing an alcohol based solution and then in a second stage by supercritical CO₂ extraction to produce processed green coffee beans; and

drying the processed green coffee beans in an initial stage as a result of the supercritical CO₂ extraction followed by a final stage of ambient drying to form the depleted coffee beans for cleaning food residue from a food processing grinder.

An advantage of this method of extraction is that a broad range of materials, free from chemical modification or cross-contamination, may be individually extracted. Selected co-solvents in supercritical fluids may be employed to tailor the extraction conditions to particular chemical compounds that have low, or limited, solubility in supercritical CO₂. In addition, the process efficiency may be fine-tuned by modifying the mixtures of supercritical solvents, via temperature, pressure and time process modifications, to gain maximum extraction yield with minimal input of time, energy and materials.

As would be appreciated, this process allows the extract by-product to be potentially on-sold to producers of food products.

In other embodiments, the supercritical extraction conditions may be optimised to remove the need for initial water and ethanol extraction steps, ie the expansion and extraction may be achieved using different stages of the supercritical process. In this case, expansion, extraction and drying would occur in-situ without additional processing.

### Method 6 (Water, Super- or Sub-Critical Fluid Extraction)

Referring now to FIG. 8, there is shown a method 800 for forming depleted coffee beans according to a further illustrative embodiment that employs a combined extraction drying stage. In this embodiment, the expansion process 320 involves unfiltered tap water being added to green Robusta coffee beans in a proportion of 10 litres for every kilogram of green coffee beans and heated at 60° C. for 4 hours. The beans are filtered, the filtrate discarded and the beans soaked in cold water for a period of 30 mins. The beans are then collected by decanting the liquid.

The extraction process 330 involves supercritical fluid extraction, using supercritical fluids that do not include CO₂, e.g. short-chain hydrocarbon mixtures. A method of stepwise increase in vessel pressure, similar to that of supercritical CO₂ extraction, is used to extract a broad range of target compounds. For the drying process 210, removal of water is achieved with positive solvent flow through the vessel during extraction.

In summary, Method 6 accordingly involves processing green coffee beans by:

expanding the green coffee beans by soaking in heated water;

extraction of active components from the expanded green coffee beans employing a supercritical fluid to produce processed green coffee beans; and

drying the processed green coffee beans by use of the supercritical fluid to form the depleted coffee beans for cleaning food residue from a food processing grinder.

As would be appreciated, the above methods and processes may be varied in accordance with the desired characteristics of the grinder cleaner that is to be produced. In terms of the extraction of active components this may involve extracting a broad range of compounds in single extraction process or alternatively a series of targeted extraction processes may be employed in succession each directed to certain individual or classes of compounds which in combination will extract a broad range of compounds. This process may be beneficially employed to then extract a particular compound as an individual component for further commercial exploitation. Although typically the expansion step occurs prior to extraction, it can be performed after extraction and in some case may be combined with the extraction process.

Depleted coffee beans may be formed in accordance with the present disclosure so as to have a percentage size increase as compared to the original coffee beans in the range, including but not limited to, of less than 10%, 10%-20%, 20%-30%, 30%-40%, 40%-50%, 50%-60%, 60%-70%, 70%-80%, 80%-90%, or 90%-100%. In one example, the percentage size increase of the depleted coffee beans formed in accordance with the above described processes is about or at least 50%. In another example, the percentage size increase of the depleted coffee beans formed in accordance with the above described processes is about or at least 75%.

Depleted coffee beans may be formed in accordance with the present disclosure so as to have a moisture content in the range, including but not limited to, of less than 1%, 1%-2%, 2%-3%, 3%-4%, 4%-5%, 5%-6%, 7%-8%, 9%-10%, 10%-11% or 11%-12%. In one example, the moisture content of the depleted coffee beans formed in accordance with the above described processes is reduced to less than or about 4%. In another example, the moisture content of the depleted coffee beans formed in accordance with the above described processes is reduced to less than or about 1%.

Depleted coffee beans may be formed in accordance with the present disclosure so as to have a hardness, as measured by a tablet hardness tester, in the range of, including but not limited to, of less than 50 N, 50 N 75 N, 75 N 100 N, 100 N 125 N or 125 N 150 N. In one example, the hardness of the depleted coffee beans formed in accordance with the above described processes is less than or about 125 N. In another example, the hardness of the depleted coffee beans formed in accordance with the above described processes is less than or about 75 N. As would be appreciated, correct orientation of the depleted coffee bean in the testing equipment is recommended in order to achieve accurate and reproducible hardness results.

Depleted coffee beans may also be formed in accordance with the present disclosure so as to have a hardness no harder than the original green been or formed to have a hardness approximating that of a commercially supplied roasted coffee bean.

Depleted coffee beans may be formed in accordance with the present disclosure so as to have a density in the range of, including but not limited to, less than 0.25 g/cm3, 0.25 g/cm3-0.30 g/cm3, 0.30 g/cm3-0.35 g/cm3, 0.35 g/cm3-0.40 g/cm3, 0.40 g/cm3-0.45 g/cm3 or 0.45 g/cm3-0.50 g/cm3. In one example, the density of the depleted coffee beans formed in accordance with the above described processes is less than or about 0.5 g/cm3. In another example, the density of the depleted coffee beans formed in accordance with the above described processes is less than or about 0.4 g/cm3.

The depleted coffee beans may be formed in accordance with the present disclosure to have a percentage weight for weight oil or fat content range of, as measured in accordance with either the standard Association of Official Analytical Chemists (AOAC) soxhlet method (1995, various solvent choices), Weibull-Stoldt method or Werner-Schmid method, including but not limited to, of less than 1.0%, 1.0-2.0%, 2.0-3.0%, 4.0%-5.0%, 5.0%-7.5%, 7.5%-10%.

Alternatively, this may be expressed in terms of a reduction in the total extractable oil content of a green coffee bean. In one example, the reduction in the total extractable oil content of the depleted coffee beans formed in accordance with the above described processes is greater than or about 50%. In another example, the reduction in the total extractable oil content of the depleted coffee beans formed in accordance with the above described processes is greater than or about 90%.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope of the invention as set forth and defined by the following claims.

1. A method for producing a grinder cleaner for cleaning food residue from a food processing grinder, the method including processing green coffee beans to form depleted coffee beans, wherein the depleted coffee beans have enhanced cleaning characteristics allowing the depleted coffee beans to clean food residue from the food processing grinder upon grinding of the depleted coffee beans.

2. The method of claim 1, wherein processing the green coffee beans includes:
extracting active components from the green coffee beans to produce processed green coffee beans; and
drying the processed coffee beans to form the depleted coffee beans.

3. The method of claim 2, wherein extracting active components from the green coffee beans includes one or more of the following processes:
aqueous extraction;
acidic or alkaline aqueous solution based extraction;
extraction by a volatile alcohol, including extraction by methanol, ethanol or isopropanol;
organic solvent extraction;
extraction by an oxidising or reducing agent;
extraction by an enzyme or biological agent;
extraction by a surface-active agent;
super or sub-critical fluid extraction; or
distillation based extraction.

4. The method of claim 3, wherein extracting the active components from the green coffee beans further includes expanding the green coffee beans to form expanded beans of increased physical size.

5. The method of claim 4, wherein expanding the green coffee beans assists in the extraction of active components from the green coffee beans.

6. The method of claim 4, wherein expanding the green coffee beans includes soaking the green coffee beans in a liquid to cause them to swell.

7. The method of claim 2, wherein drying the processed coffee beans includes one or more of the following processes:
conventional oven/heated drying;
microwave drying;
freeze-drying;
super or sub-critical fluid drying;
ambient drying;
chemical drying by a water absorbing material;
modified pressure drying; or
puffing.

8. The method of claim 1, wherein the formed depleted coffee beans have a moisture content less than or about 4%.

9. The method of claim 8, wherein the moisture content is less than or about 1%.

10. The method of claim 1, wherein the formed depleted coffee beans have a hardness of less than or about 125 N.

11. The method of claim 10, wherein the hardness is less than or about 75 N.

12. The method of claim 1, wherein the formed depleted coffee beans have a hardness no harder than the original coffee beans.

13. The method of claim 1, wherein the formed depleted coffee beans have a percentage size increase of about or greater than 50%.

14. The method of claim 13, wherein the percentage size increase is about or greater than 75%.

15. The method of claim 1, wherein the formed depleted coffee beans have a reduction in extractable fat content of about or greater than 50%.

16. The method of claim 15, wherein the reduction in extractable fat content is about or greater than 90%.

17. The method of claim 1, wherein the formed depleted coffee beans have a density of less than or about 0.5 g/cm³.

18. The method of claim 17, wherein the density is less than or about 0.4 g/cm³.

19. A grinder cleaner comprising the depleted coffee beans formed by the method of claim 1.

20. A method for cleaning food residue from a food processing grinder including:
introducing the grinder cleaner of claim 19 into the food processing grinder;
grinding the depleted coffee beans; and
purging the ground depleted coffee beans from the grinder.

21. The method of claim 20, wherein the food processing grinder is a coffee grinder.
